(19) United States
(12) Patent Application Publication
(10) Pub. No.: US 2014/0050939 A1
(43) Pub. Date: Feb. 20, 2014

(54) SURFACE-TREATED METAL MATERIAL AND AQUEOUS METAL SURFACE-TREATMENT AGENT

(71) Applicants: Atsushi Morishita, Tokyo (JP); Taihei Kaneto, Tokyo (JP); Yoshio Kimata, Tokyo (JP); Akira Takahashi, Tokyo (JP); Ikuo Kikuchi, Tokyo (JP); Hidehiro Yamaguchi, Tokyo (JP); Shinji Nomura, Tokyo (JP)

(72) Inventors: Atsushi Morishita, Tokyo (JP); Taihei Kaneto, Tokyo (JP); Yoshio Kimata, Tokyo (JP); Akira Takahashi, Tokyo (JP); Ikuo Kikuchi, Tokyo (JP); Hidehiro Yamaguchi, Tokyo (JP); Shinji Nomura, Tokyo (JP)

(73) Assignees: NIHON PARKERIZING CO., LTD., Tokyo (JP); NIPPON STEEL & SUMITOMO METAL CORPORATION, Tokyo (JP)

(21) Appl. No.: 14/113,502

(22) PCT Filed: Apr. 26, 2012
(86) PCT No.: PCT/JP2012/061233

§ 371 Date: Oct. 23, 2013

(30) Foreign Application Priority Data
Apr. 27, 2011 (JP) 2011-100126

(51) Int. Cl. C09D 7/12

(52) U.S. Cl. CPC C09D 7/1233
USPC 428/626; 106/287.11; 428/447; 428/341

(57) ABSTRACT

A surface-treated metal material of the present invention has a composite film on the surface of a metal material. The composite film includes an organic silicon compound (W) having cyclic siloxane bonds, at least one metal compound (X) selected from a group consisting of a titanium compound and a zirconium compound, a phosphate compound (Y) and a fluorine compound (Z). In each of the components of the composite film, the ratio of X_{S}/W_{S} is from 0.06 to 0.16, where W_{S} is a solid mass of Si derived from the organic silicon compound (W) and X_{S} is a solid mass of at least one metal component selected from a group consisting of Ti and Zr included in the metal compound (X); the ratio of Y_{S}/W_{S} is from 0.15 to 0.31, where W_{S} is the solid mass of Si and Y_{S} is a solid mass of P derived from the phosphate compound (Y); and the ratio of Z_{S}/W_{S} is from 0.08 to 0.50, where W_{S} is the solid mass of Si and Z_{S} is a solid mass of F derived from the fluorine compound (Z).

### TECHNICAL FIELD

The present invention relates to a metal material subjected to a chromate-free surface treatment which has excellent corrosion resistance, heat resistance, anti-fingerprint properties, electrical conductivity, paintability and black shaving resistance during processing, and an aqueous metal surface-treatment agent used for the relevant surface treatment. More specifically, the present invention relates to a metal material subjected to a chromate-free surface treatment which can retain excellent corrosion resistance without being affected by the alkaline degreasing, bending and punching that are conducted when the surface-treated metal material is processed into a stamped article and in addition, has excellent heat resistance, anti-fingerprint properties, electrical conductivity, paintability and black shaving resistance during processing, and an aqueous metal surface-treatment agent used for the relevant surface treatment.

Priority is claimed on Japanese Patent Application No. 2011-100126, filed on Apr. 27, 2011, and the content of which is incorporated herein by reference.

### BACKGROUND ART

As a technology which has excellent adhesion to the surface of a metal material and imparts corrosion resistance, anti-fingerprint properties, or the like on the surface of the metal material, the following methods have been generally known and put in practice: a method in which a chromate treatment is carried out on the surface of a metal material by use of a treatment solution containing chromic acid, dichromic acid or salt thereof as a main component, a method in which a phosphate treatment is carried out, a method in which a treatment is carried out by use of a silane coupling agent alone, a method in which an organic-resin film treatment is carried out, or the like.

As a technology using mainly inorganic components, Patent Document 1 cites a metal surface-treatment agent containing a vanadium compound and a metal compound which includes at least one metal selected from a group consisting of zirconium, titanium, molybdenum, tungsten, manganese and cerium.

On the other hand, as a technology using mainly a silane coupling agent, Patent Document 2 discloses the treatment of a metal sheet by use of an aqueous solution containing low concentration of organic functional silanes and a cross-linking agent to obtain a temporary anticorrosive effect. A method is disclosed in which a cross-linking agent establishes cross-links between organic functional silanes to form a dense siloxane film.

In addition, Patent Document 3 discloses a non-chrome based surface-treated metal sheet which has excellent corrosion resistance, and in addition, excellent anti-fingerprint properties, blackening resistance and paint adhesion and a method of manufacturing the same, when a surface treatment agent is used which contains a specific resin compound (A), a cationic urethane resin (B) having at least one cationic functional group selected from a group consisting of primary to tertiary amino groups and quaternary ammonium base, one or more types of silane coupling agents (C) having a specific reactive functional group and a specific acid compound (E), and has amounts of the cationic urethane resin (B) and the silane coupling agents (C) within a predetermined range.

Furthermore, Patent Document 4 discloses a technology in which silane coupling agents are used as main components, a treatment solution with a specific pH is prepared from a treatment agent which includes a silane coupling agent I having a specific functional group A and a silane coupling agent II having a different functional group B which can react with the functional group A, and the surface of a metal material is coated with the treatment solution, heated and dried to form a film which includes reaction products of the silane coupling agents I and II.

In addition, Patent Document 5 discloses a technology which uses a surface treatment agent for a metal material containing a compound having two or more functional groups with specific structures as (a) components and at least one compound selected from a group consisting of an organic acid, phosphoric acid and fluoride complex as a (b) component, and having a molecular weight of 100-30,000 per functional group in the (a) component, and has excellent corrosion resistance.

However, the technologies in Patent Documents 1 to 3 do not have all of sufficient corrosion resistance, heat resistance, anti-fingerprint properties, electrical conductivity, paintability and black shaving resistance during processing, and still have problems when it comes to practical uses. In addition, the technologies in Patent Documents 4 to 5 use silane coupling agents as main components and mix a plurality of silane coupling agents for use. However, hydrolysis and condensation of a silane coupling agent, and reactivity of an organic functional group and effects obtained thereby are not sufficiently examined, and a technology is not disclosed in which the properties of a plurality of silane coupling agents are sufficiently controlled.

Furthermore, Patent Document 6 discloses a chromate-free surface-treated metal material which has a composite film formed thereon containing each component when the surface of a metal material is coated with an aqueous metal surface-treatment agent containing an organic silicon compound (W) obtained by mixing two types of silane coupling agents with specific structures at specific mass ratio and a specific inhibitor, and the surface-treated metal material is dried. The technology is an excellent technology which has been put into practice as a surface-treated metal sheet subjected to a chromate-free surface treatment which has excellent corrosion resistance, heat resistance, anti-fingerprint properties, electrical conductivity, paintability and black shaving resistance during processing. However, a surface-treated metal sheet is required to have a high-performance composite film.

### PRIOR ART DOCUMENT

### Patent Document

[Patent Document 1] Japanese Unexamined Patent Application, First Publication No. 2002-30460
[Patent Document 2] U.S. Pat. No. 5,292,549 Specification
[Patent Document 3] Japanese Unexamined Patent Application, First Publication No. 2003-105562
[Patent Document 4] Japanese Unexamined Patent Application, First Publication No. H8-73775
[Patent Document 5] Japanese Unexamined Patent Application, First Publication No. 2001-49453
[Patent Document 6] Japanese Unexamined Patent Application, First Publication No. 2007-051365

### Disclosure of the Invention

### Problem that the Invention is to Solve

The present invention solves the problems with the related art and provides a metal material subjected to a chromate-free surface treatment which is excellent in terms of corrosion resistance, heat resistance, anti-fingerprint properties, electrical conductivity, paintability and black shaving resistance during processing and an aqueous metal surface-treatment agent used for the relevant surface treatment. More specifically, the present invention relates to a metal material subjected to a chromate-free surface treatment which can retain excellent corrosion resistance without being affected by the alkaline degreasing, bending and punching that are conducted when the surface-treated metal material is processed into a stamped article, and in addition, has excellent heat resistance, anti-fingerprint properties, electrical conductivity, paintability and black shaving resistance during processing, and an aqueous metal surface-treatment agent used for the relevant surface treatment.

### Means for Solving the Problems

The present invention has been completed upon intensive examinations that the inventors have repeatedly conducted to solve the above-described problems. In the present invention, a surface-treated metal material includes a composite film formed on a surface of a metal material and is subjected to a chromate-free surface treatment, the composite film including, as a film forming component, an organic silicon compound (W) with a specific structure; as inhibitor components, at least one metal compound (X) selected from a group consisting of a titanium compound and a zirconium compound; a phosphate compound (Y); and a fluorine compound (Z), all of which are essential components, and each component of the composite film has a specific percent. The surface-treated metal material has excellent corrosion resistance, heat resistance, anti-fingerprint properties, electrical conductivity, paintability and black shaving resistance during processing, and can retain excellent corrosion resistance without being affected by the alkaline degreasing, bending and punching that are conducted when a surface-treated metal material is processed into a stamped article.

According to an aspect of the present invention, a surface-treated metal material has a composite film on a surface of the metal material. The composite film includes: as a film forming component, (i) an organic silicon compound (W) having cyclic siloxane bonds in the structure thereof; as inhibitor components, (ii) at least one metal compound (X) selected from a group consisting of a titanium compound and a zirconium compound; (iii) a phosphate compound (Y); and (iv) a fluorine compound (Z). In each of the components of the composite film, the ratio of X_{S}/W_{S} is from 0.06 to 0.16, where W_{S} is the solid mass of Si derived from the organic silicon compound (W) and X_{S} is the solid mass of at least one metal component selected from a group consisting of Ti and Zr included in the metal compound (X); the ratio of Y_{S}/W_{S} is from 0.15 to 0.31, where W_{S} is the solid mass of Si derived from the organic silicon compound (W) and Y_{S} is a solid mass of P derived from the phosphate compound (Y); the ratio of Z_{S}/W_{S} is from 0.08 to 0.50, where W_{S} is the solid mass of Si derived from the organic silicon compound (W) and Z_{S} is the solid mass of F derived from the fluorine compound (Z); and, in the composite film, the amount of an organic resin with a mean molecular weight equal to or greater than 3,000 is limited to less than 10 mass % of the total weight of the film.

In addition, the abundance of cyclic siloxane bonds and chain siloxane bonds of the organic silicon compound (W) is preferably the ratio of W₁/W₂ ranging from 1.0 to 2.0, where W₁ is an absorbance of from 1,090 to 1,100 cm⁻¹ indicating the cyclic siloxane bond by the FT-IR reflection method and W₂ is an absorbance of from 1,030 to 1,040 cm⁻¹ indicating the chain siloxane bond.

It is preferable that the film forming component of the composite film does not preferably contain an organic resin of which a mean molecular weight is equal to or greater than 3,000.

The film forming component of the composite film is preferably composed of only the organic silicon compound (W).

The metal compound (X) and the fluorine compound (Z) are preferably at least one fluoro compound selected from a group consisting of titanium hydrofluoric acid and zirconium hydrofluoric acid.

When an interlayer resistance coefficient of the surface-treated metal material is measured by a JIS C2550-4: 2011-A method where the total area of 10 pieces of contact electrodes is 1,000 mm², the coefficient is preferably less than 200 Ω·mm² in terms of excellence of electrical conductivity.

Furthermore, it is preferable that the composite film contains, as a component (C), at least one cobalt compound selected from a group consisting of cobalt sulphate, cobalt nitrate and cobalt carbonate at a ratio of C_{S}/W_{S} ranging from 0.03 to 0.08, where W_{S} is the solid mass of Si derived from the organic silicon compound (W) and C_{S} is the solid mass of Co derived from the cobalt compound (C).

In addition, the metal material is preferably a zinc-plated steel sheet.

In addition, according to another aspect of the present invention, an aqueous metal surface-treatment agent includes: (i) an organic silicon compound (W) having cyclic siloxane bonds in the structure thereof; (ii) at least one metal compound (X) selected from a group consisting of a titanium compound and a zirconium compound; (iii) a phosphate compound (Y); and (iv) a fluorine compound (Z). In each of the components of the aqueous metal surface-treatment agent, the ratio of X_{S}/W_{S} is from 0.06 to 0.16, where W_{S} is the solid mass of Si derived from the organic silicon compound (W) and X_{S} is the solid mass of at least one metal component selected from a group consisting of Ti and Zr included in the metal compound (X); the ratio of Y_{S}/W_{S} is from 0.15 to 0.31, where W_{S} is the solid mass of Si derived from the organic silicon compound (W) and Y_{S} is a solid mass of P derived from the phosphate compound (Y); the ratio of Z_{S}/W_{S} is from 0.08 to 0.50, where W_{S} is the solid mass of Si derived from the organic silicon compound (W) and Z_{S} is a solid mass of F derived from the fluorine compound (Z), and the amount of an organic resin of which a mean molecular weight is equal to or greater than 3,000 is limited to less than 10 mass % of the total mass of the solids.

The organic silicon compound (W) of the aqueous metal surface-treatment agent is obtained by mixing a silane coupling agent A containing at least one amino group per molecule and a silane coupling agent B containing at least one glycidyl group per molecule at a solid mass ratio A/B ranging from 0.5 to 1.7. It is preferable that the organic silicon compound (W) contains, per molecule, two or more functional groups (a) represented by a formula —SiR¹R²R³ and one or more hydrophilic functional groups (b) which have at least one selected from a group consisting of a hydroxyl group (when a functional group (a) includes a hydroxyl group, the hydroxyl group included in the functional group (a) is discrete) and an amino group, where the R¹′, R² and R³ are an alkoxy group or a hydroxyl group independently of one another, at least one of the R¹′, R² and R³ is an alkoxy group, and the mean molecular weight of the organic silicon compound (W) is from 1,000 to 10,000.

The metal compound (X) and the fluorine compound (Z) are preferably at least one fluoro compound selected from a group consisting of titanium hydrofluoric acid and zirconium hydrofluoric acid.

In addition, it is preferable that a surface-treated metal material is coated with an aqueous metal surface-treatment agent on a surface of the metal material and is dried, and a composite film has a weight of from 0.05 to 2.0 g/m² after drying is completed.

### Advantage of the Invention

The surface-treated metal material and the aqueous metal surface-treatment agent of the present invention can retain excellent corrosion resistance without being affected by the alkaline degreasing, bending and punching that are conducted when the surface-treated metal material is processed into a stamped article, and in addition, is excellent in terms of heat resistance, anti-fingerprint property, electrical conductivity, paintability and black shaving resistance during processing.

### BEST MODE FOR CARRYING OUT THE INVENTION

In the present invention, an applicable metal material is not particularly specified. For example, iron, an iron-based alloy, aluminum, an aluminum-based alloy, copper, a copper-based alloy and the like are cited, and, as necessary, a metal material which has plating on the surface thereof can be used. Above all, in the present invention, the most preferable material is a zinc-plated steel sheet. A galvanized steel sheet, a zinc-nickel plated steel sheet, a zinc-iron plated steel sheet, a zinc-chromium plated steel sheet, a zinc-aluminum plated steel sheet, a zinc-titanium plated steel sheet, a zinc-magnesium plated steel sheet, a zinc-manganese plated steel sheet, a zinc-aluminum-magnesium plated steel sheet, a zinc-aluminum-magnesium-silicon plated steel sheet and the like are cited as a zinc-plated steel sheet. Furthermore, a zinc-plated steel sheet can be used of which the plating layer contains, as a different metal element or impurities, a small amount of cobalt, molybdenum, tungsten, nickel, titanium, chromium, aluminum, manganese, iron, magnesium, lead, bismuth, antimony, tin, copper, cadmium, arsenic or the like, or has an inorganic substance such as silica, alumina and titania dispersed therein. Furthermore, the above-described plating can be used in combination with other types of plating. For example, a multilayer of plating is applicable in which the above-described plating is combined with iron plating, iron-phosphorous plating, nickel plating, cobalt plating or the like. A plating method is not particularly specified, and any widely known method, such as an electro plating method, a hot dip plating method, a vapor deposition plating method, a dispersion plating method, a vacuum plating method and the like may be used.

An organic silicon compound (W) is an essential component as a film forming component of an aqueous metal surface-treatment agent used for a chromate-free surface-treated metal material of the present invention, and has cyclic siloxane bonds in the structure thereof. Herein, the “cyclic siloxane bond” indicates a cyclic structure which has a configuration of continuous Si—O—Si bonds, is configured with only Si—O bonds and has a number of the Si—O repetition units of 3 to 8. On the other hand, the “chain siloxane bond” indicates a structure which has a configuration of continuous Si—O—Si bonds, is configured with only Si—O bonds, has a number of the Si—O repetition units of 3 to 8 and does not have the cyclic structures. When the organic silicon compound (W) does not contain cyclic siloxane bonds in the structure thereof, a apparent degree of cross-linking of a film is decreased, decomposition of a film due to alkali or heat generated during processing or cohesive failure of a film due to processing load is not restrained, a coarse film is formed, and thus, the excellent corrosion resistance of the present invention can be not retained. In addition, the heat resistance and black shaving resistance during processing, which are the effects of the present invention, are inferior. Herein, “black shaving resistance during processing” indicates resistance to a phenomenon that, when a metal material is subjected to processing such as press working, the surface of the metal material strongly slides against a press die or the like, and black sludge-like substance is formed from a film covering the surface of the metal material, is fixed and accumulated, thereby impairing the appearance thereof.

An organic silicon compound (W), which is an essential component as a film forming component of an aqueous metal surface-treatment agent used for a chromate-free surface-treated metal material of the present invention, is obtained by mixing a silane coupling agent (A) containing at least one amino group per molecule and a silane coupling agent (B) containing at least one glycidyl group per molecule at a solid mass ratio [(A)/(B)] ranging from 0.5 to 1.7. It is preferable that an organic silicon compound (W) obtained in this way contain, per molecule, two or more functional groups (a) represented by a formula —SiR¹R²R³ (wherein, R¹′, R² and R³ each represent an alkoxy group or a hydroxyl group independently of one another, and at least one of R¹′, R² and R³ represents an alkoxy group) and one or more hydrophilic functional groups (b) which have at least one selected from a group consisting of a hydroxyl group (when a functional group (a) includes a hydroxyl group, the hydroxyl group included in the functional group (a) is discrete) and an amino group, and the mean molecular weight of an organic silicon compound (W) is from 1,000 to 10,000.

The solid mass ratio [(A)/(B)] of a silane coupling agent (A) and a silane coupling agent (B) is preferably from 0.5 to 1.7, in which the silane coupling agent (A) has at least one amino group per molecule and the silane coupling agent (B) has at least one glycidyl group per molecule, and is more preferably from 0.6 to 1.5. When the solid mass ratio [(A)/(B)] is from 0.5 to 1.7, an efficient and stable organic silicon compound of the present invention is produced, and a film can be formed which has excellent corrosion resistance, heat resistance, anti-fingerprint properties, electrical conductivity, paintability and black shaving resistance during processing. Furthermore, when the ratio [(A)/(B)] is in a preferable range of from 0.6 to 1.5, the corrosion resistance can be further improved.

The silane coupling agent (A) is not particularly specified. However, 3-aminopropyltriethoxysilane, 3-aminopropyltrimethoxysilane or the like are exemplary examples. Examples of the silane coupling agent (B) include 3-glycidoxypropyltrimethoxysilane, 3-glycidoxypropyltriethoxysilane and the like.

In addition, an organic silicon compound of the present invention preferably contains, per molecule, two or more functional groups (a) represented by a formula —SiR¹R²R³ (wherein, R¹′, R² and R³ each represent an alkoxy group or a hydroxyl group independently of one another, and at least one of R¹′, R² and R³ represents an alkoxy group). When two or more of the functional groups (a) described above are included per molecule, it is possible to regularly and densely arrange silicon-containing portions and organic substance portions in a film, and to obtain the excellent film which has heat resistance, electrical conductivity and black shaving resistance during processing usually exhibited by an inorganic film, and the anti-fingerprint properties and paintability usually exhibited by an organic film.

In addition, an organic silicon compound of the present invention preferably contains one or more hydrophilic functional groups (b) which have at least one selected from a group consisting of a hydroxyl group (when a functional group (a) includes a hydroxyl group, the hydroxyl group included in the functional group (a) is discrete) and an amino group. In addition, the mean molecular weight is preferably from 1,000 to 10,000, and is more preferably from 1,300 to 6,000. Herein, the molecular weight is not particularly specified. However, the molecular weight can be measured by use of any measurement of a direct measurement by TOF-MS method or a conversion measurement by a chromatographic method. When the mean molecular weight is in a range from 1,000 to 10,000, the water resistance of a formed film is well-balanced with the dissolution stability or dispersion stability of the organic silicon compound.

In addition, the abundance of cyclic siloxane bonds and chain siloxane bonds of the organic silicon compound (W) can be measured by a reflection method using Fourier transform infrared spectrophotometer (FT-IR). The ratio of [W₁/W₂] is preferably from 1.0 to 2.0, where (W₁) is an absorbance of from 1,090 to 1,100 cm⁻¹ indicating the cyclic siloxane bond and (W₂) is an absorbance of from 1,030 to 1,040 cm⁻¹ indicating the chain siloxane bond. Furthermore, the ratio [W₁/W₂] is more preferably from 1.2 to 1.8. When the ratio [W₁/W₂] is in a range from 1.0 to 2.0, the excellent barrier properties and resistance to alkali or heat which are exhibited by the cyclic siloxane bond, and pliability due to the chain siloxane bond are obtained. Accordingly, a film can retain excellent corrosion resistance without being affected by the alkaline degreasing, bending and punching that are conducted when the surface-treated metal material is processed into a stamped article, and in addition, a film can be formed which has excellent heat resistance, anti-fingerprint properties, electrical conductivity, paintability and black shaving resistance during processing.

In addition, the method of manufacturing an organic silicon compound (W) of the present invention is not particularly specified. However, a method is cited where the silane coupling agent (A) and the silane coupling agent (B) are sequentially added to water adjusted to a pH 4, and the resultant solution is agitated for a predetermined time. Herein, when the silane coupling agent (A) is added, the aqueous solution generates heat. For this reason, water is cooled in advance, continues to be cooled for a predetermined time, and the organic silicon compound (W) is manufactured in a certain temperature range, thereby allowing control of the abundance of cyclic silane bonds and chain silane bonds in the organic silicon compound (W). Specifically, when the temperature is controlled to be in a range from 15 to 30° C., it is preferable because the ratio [W₁/W₂] become from 1.0 to 2.0. However, when the temperature is increased to a temperature higher than 30° C., the percentage of the cyclic siloxane bond being produced becomes insufficient, the ratio [W₁/W₂] becomes less than 1.0, and thus, the barrier properties and corrosion resistance are deteriorated. Accordingly, a temperature higher than 30° C. is not preferable. In addition, when the temperature is lower than 15° C., the percentage of the cyclic siloxane bond being produced becomes excessive, the ratio [W₁/W₂] becomes more than 2.0, and thus, the film becomes too brittle and the workability is deteriorated. Accordingly, a temperature lower than 15° C. is not preferable.

An aqueous metal surface-treatment agent of the present invention necessarily contains, as an inhibitor component, at least one metal compound (X) selected from a group consisting of a titanium compound and a zirconium compound. A titanium compound is not particularly specified. However, titanium hydrofluoric acid, titanium ammonium fluoride, titanium sulfate, titanium oxysulfate, potassium titanium oxide oxalate or the like are exemplary examples. Above all, titanium hydrofluoric acid is more preferable. When titanium hydrofluoric acid is used, better corrosion resistance or paintability can be obtained.

The zirconium compound is not particularly specified. However, zirconium hydrofluoric acid, zirconium ammonium fluoride, zirconium sulfate, zirconium oxychloride, zirconium nitrate, zirconium acetate or the like are exemplary examples. Zirconium hydrofluoric acid is the most preferable. When zirconium hydrofluoric acid is used, better corrosion resistance or paintability can be obtained.

In addition, in regard to a blending quantity of a metal compound (X) which is an essential component of the present invention, the solid mass ratio [(X_{S})/(W_{S})] is necessarily from 0.06 to 0.16, where (W_{S}) is the solid mass of Si derived from an organic silicon compound (W), and (X_{S}) is the solid mass of at least one metal component selected from a group consisting of Ti and Zr included in the metal compound (X). The solid mass ratio [(X_{S})/(W_{S})] is preferably from 0.07 to 0.14, and is more preferably from 0.08 to 0.13. When the solid mass ratio [(X_{S})/(W_{S})] is less than 0.06, where (W_{S}) is a solid mass of Si derived from the organic silicon compound (W) and (X_{S}) is a solid mass of at least one metal component selected from a group consisting of Ti and Zr included in the metal compound (X), the effect of the metal compound (X) is not exhibited, the removing of oxide film from the surface of a metal material or reactivity between an organic silicon material (W) of the present invention and the surface of a metal material to be treated is deteriorated, the adhesion and barrier effects of a formed composite film are deteriorated, and thus, the overall performance is insufficient. Accordingly, a solid mass ratio [(X_{S})/(W_{S})] less than 0.06 is not preferable. On the other hand, when the solid mass ratio [(X_{S})/(W_{S})] exceeds 0.16, a reaction film is excessively formed on the surface of a metal material to be treated due to a metal compound (X), and thus, the electrical conductivity is remarkably deteriorated. Accordingly, a solid mass ratio [(X_{S})/(W_{S})] exceeding 0.16 is not preferable.

In addition, an aqueous metal surface-treatment agent of the present invention necessarily contains a phosphate compound (Y) as an inhibitor component. The phosphate compound (Y) is not particularly specified. However, phosphoric acid, ammonium phosphate, potassium phosphate, sodium phosphate or the like are exemplary examples. Phosphoric acid is the most preferable. When phosphoric acid is used, better corrosion resistance can be obtained.

In regard to a blending quantity of a phosphate compound (Y) which is an essential component of the present invention, the solid mass ratio [(Y_{S})/(W_{S})] is necessarily from 0.15 to 0.31, where (W_{S}) is a solid mass of Si derived from an organic silicon compound (W) and (Y_{S}) is a solid mass of P derived from a phosphate compound (Y). The solid mass ratio [(Y_{S})/(W_{S})] is preferably from 0.16 to 0.28, and is more preferably from 0.18 to 0.25. When a solid mass ratio [(Y_{S})/(W_{S})] is less than 0.15, where (W_{S}) is the solid mass of Si derived from the organic silicon compound (W) and (Y_{S}) is a solid mass of P derived from a phosphate compound (Y), the eluting inhibitor effect of a phosphate compound (Y) is not obtained, and thus, a solid mass ratio [(Y_{S})/(W_{S})] less than 0.15 is not preferable. On the contrary, when the solid mass ratio [(Y_{S})/(W_{S})] exceeds 0.31, the film is remarkably water-soluble, and thus, a solid mass ratio [(Y_{S})/(W_{S})] exceeding 0.31 is not preferable.

In addition, an aqueous metal surface-treatment agent of the present invention necessarily contains a fluorine compound (Z) as an inhibitor component. The fluoric compound (Z) is not particularly specified. However, fluoride such as hydrofluoric acid, hydrofluoboric acid, hydrosilicofluoric acid and water soluble salts thereof and a fluoride salt complex are exemplary examples. Hydrofluoric acid is the most preferable. When hydrofluoric acid is used, better corrosion resistance and paintability can be obtained.

In addition, when hydrofluoric acid is used, titanium hydrofluoric acid or zirconium hydrofluoric acid can be more preferably used as the above-described metal compound (X). In this case, better corrosion resistance or paintability can be obtained.

In regard to a blending quantity of a fluorine compound (Z) which is an essential component of the present invention, the solid mass ratio [(Z_{S})/(W_{S})] is necessarily from 0.08 to 0.50, where (W_{S}) is the solid mass of Si derived from an organic silicon compound (W) and (Z_{S}) is the solid mass of F derived from a fluorine compound (Z). The solid mass ratio [(Z_{S})/(W_{S})] is preferably from 0.10 to 0.40, and is more preferably from 0.15 to 0.30. When the solid mass ratio [(Z_{S})/(W_{S})] is less than 0.08 where (W_{S}) is the solid mass of Si derived from the organic silicon compound (W) and (Z_{S}) is a solid mass of F derived from a fluorine compound (Z), a sufficient corrosion resistance is not obtained, and thus, a solid mass ratio [(Z_{S})/(W_{S})] less than 0.08 is not preferable. On the other hand, when the solid mass ratio [(Z_{S})/(W_{S})] exceeds 0.50, the film is remarkably water-soluble, and thus, a solid mass ratio [(Z_{S})/(W_{S})] exceeding 0.50 is not preferable.

In addition, in an aqueous metal surface-treatment agent of the present invention, an organic resin having a mean molecular weight of equal to or greater than 3,000 as a film forming component is necessarily limited to less than 10 mass % of the total solid content (that is, a total film weight) of the aqueous metal surface-treatment agent. Herein, the “organic resin” indicates both a natural resin and a synthetic resin, and is not particularly specified. Specifically, rosin, natural rubber or the like taken from a plant is cited as a natural resin, and phenolic resin, epoxy resin, melamine resin, urea resin, unsaturated polyester resin, alkyd resin, polyurethane resin, thermosetting polyimide resin, acrylic resin, or the like is cited as a synthetic resin. The resin is either dispersed or water-soluble in an aqueous system. An organic resin does not include an organic silicon compound (W) in the present invention. The “mean molecular weight of equal to or greater than 3,000” is defined because the molecular weights of a natural resin such as rosin or natural rubber and a synthetic resin such as phenolic resin are generally equal to or greater than 3,000. The mean molecular weight of a resin is not particularly specified. The molecular weight can be measured using a direct measurement method such as a TOF-MS method or a conversion measurement method such as a chromatographic method. When an aqueous metal surface-treatment agent of the present invention contains an organic resin of equal to or more than 10 mass % of the total solid content of the aqueous metal surface-treatment agent, and the contained organic resin has a mean molecular weight of equal to or greater than 3,000, an extremely degradation occurs especially in black shaving resistance and electrical conductivity, and it is not preferable that the amount of organic resin contained therein be equal to or more than 10 mass % of the total solid content. In addition, since the organic resin does not improve an excellent corrosion resistance of an aqueous metal surface-treatment agent of the present invention, the addition thereof is not required.

Furthermore, an aqueous metal surface-treatment agent of the present invention preferably contains, as a component (C), at least one cobalt compound selected from a group consisting of cobalt sulphate, cobalt nitrate and cobalt carbonate in a film. The solid mass ratio of a component (C) [(C_{S})/(W_{S})] preferably ranges from 0.03 to 0.08, where W_{S} is the solid mass of Si derived from the organic silicon compound (W) and C_{S} is a solid mass of Co derived from a cobalt compound (C). The solid mass ratio [(C_{S})/(W_{S})] is more preferably from 0.04 to 0.07, and is most preferably from 0.05 to 0.06. When the solid mass ratio [(C_{S})/(W_{S})] is from 0.03 to 0.08, where (W_{S}) is the solid mass of Si derived from the organic silicon compound (W) and (C_{S}) is a solid mass of Co derived from a cobalt compound (C), oxygen-deficient corrosion can be restrained without deteriorating the corrosion resistance, which is an effect of Co, and thus, a solid mass ratio [(C_{S})/(W_{S})] ranging from 0.03 to 0.08 is preferable.

In addition, an aqueous metal surface-treatment agent of the present invention can contain a vanadium compound. The vanadium compound (V) is not particularly specified. However, vanadium pentoxide V₂O₅, meta vanadic acid HVO₃, ammonium metavanadate, sodium metavanadate, vanadium oxytrichloride VOCl₃, vandadium trioxide V₂O₃, vanadium dioxide VO₂, vanadium oxysulfate VOSO₄, vanadium oxyacetylacetonate VO(OC(═CH₂)CH₂COCH₃)₂, vanadium acetylacetonate V(OC((═CH₂)CH₂COCH₃)₃, vanadium trichloride VCl₃, phosphovanadomolybdic acid, and the like are exemplary examples thereof. In addition, a tetravalent to divalent vanadium compound can be used, which is reduced from a pentavalent vanadium compound by an organic compound having at least one functional group selected from a group consisting of a hydroxyl group, a carbonyl group, a carboxyl group, primary to tertiary amino groups, an amide group, a phosphate group and a phosphonic acid group.

In addition, in regard to a blending quantity of a vanadium compound, the solid mass ratio [(V_{S})/(W_{S})] is preferably from 0.12 to 0.25, where (W_{S}) is a solid mass of Si derived from an organic silicon compound (W) and (V_{S}) is the solid mass of V derived from a vanadium compound. The solid mass ratio [(V_{S})/(W_{S})] is more preferably from 0.14 to 0.22, and is the most preferably from 0.15 to 0.20. The vanadium compound has an effect on not only improvement of corrosion resistance but also the raising of the performance of a film obtained by an aqueous metal surface-treatment agent of the present invention due to reaction of the vanadium compound with the organic silicon compound (W), formation of compound thereof with a phosphate compound (Y) and the like.

It is preferable that a surface-treated metal material of the present invention be coated with the aqueous metal surface-treatment agent, and be dried until a temperature reaches a temperature higher than 50° C. and lower than 250° C., and the weight of a film be from 0.05 to 2.0 g/m² after drying is completed. In regard to a drying temperature, the target temperature is preferably higher than 50° C. and lower than 250° C., is more preferably from 70° C. to 150° C., and the most preferably from 100° C. to 140° C. When the target temperature is equal to or lower than 50° C., a solvent of the aqueous metal surface-treatment agent does not completely volatilize, and thus, a target temperature equal to or less than 50° C. is not preferable. On the other hand, when the target temperature is equal to or higher than 250° C., a portion of organic chains of a film formed by the aqueous metal surface-treatment agent are decomposed, and thus, a target temperature equal to or higher than 250° C. is not preferable. The mass of a film is preferably from 0.05 to 2.0 g/m², is more preferably from 0.2 to 1.0 g/m², and is the most preferably from 0.3 to 0.6 g/m². When the mass of a film is less than 0.05 g/m², the surface of the metal material cannot be coated, and thus, corrosion resistance is remarkably deteriorated. Accordingly, the mass of a film less than 0.05 g/m² is not preferable. On the other hand, when the mass of a film is more than 2.0 g/m², black shaving resistance during processing is deteriorated, and thus, a mass of the film more than 2.0 g/m² is not preferable.

In an aqueous metal surface-treatment agent used in the present invention, a leveling agent, a water-soluble solvent, a metal stabilizer, an etching inhibitor, a pH adjuster or the like can be used to improve paintability within a limit that the effects of the present invention are not impaired. A leveling agent includes a polyethylene oxide or polypropylene oxide adduct, an acetylene glycol compound or the like as a nonionic or a cationic surfactant. Alcohols such as ethanol, isopropyl alcohol, t-butyl alcohol and propylene glycol, cellosolves such as ethylene glycol monobutyl ether and ethylene glycol monoethyl ether, esters such as ethyl acetate and butyl acetate, and ketones such as acetone, methyl ethyl ketone and methyl isobutyl ketone are cited as water-soluble solvents. Chelate compounds such as EDTA and DTPA are cited as metal stabilizers. Amine compounds such as ethylene diamine, triethylene pentamine, guanidine and pyrimidine are cited as etching inhibitors. In particular, a metal stabilizer having two or more amino groups per molecule is effective, and is more preferable. Organic acids such as acetic acid and lactic acid, inorganic acids such as hydrofluoric acid, ammonium salt, amines or like are cited as pH adjusters.

A surface-treated metal material of the present invention can retain excellent corrosion resistance without being affected by the alkaline degreasing, bending and punching that are conducted when the surface-treated metal material is processed into a stamped article, and in addition, is excellent in terms of heat resistance, anti-fingerprint properties, electrical conductivity, paintability and black shaving resistance during processing. The reasons for this are assumed to be as follows, but the present invention is not bound thereby.

A film formed by an aqueous metal surface-treatment agent used in the present invention is mainly formed by an organic silicon compound. First, it is assumed that, when a portion of the organic silicon compounds is concentrated due to drying or the like, the organic silicon compounds react with each other and form a continuous film, and a —Si—OH group, which is produced by the hydrolyzing of the portion of the organic silicon compounds, forms Si—O—M bonds (M: metal element in the surface of a material to be coated) with respect to the surface of a metal, thereby exhibiting a remarkable barrier effect and obtaining corrosion resistance. In addition, since a dense film can be formed, the film can be thin and electrical conductivity is improved.

On the other hand, a film formed by an aqueous metal surface-treatment agent of the present invention is formed on the basis of silicon, and silicon and organic chains are regularly arranged in the structure thereof. In addition, since the organic chains are relatively short, silicon-containing portions and organic substance portions, that is, an inorganic substance and an organic substance, are regularly and densely arranged in extremely minute areas of a film. For this reason, it is assumed that a new film can be formed which has the heat resistance, electrical conductivity and black shaving resistance during processing usually exhibited by an inorganic film and the anti-fingerprint properties and paintability usually exhibited by an organic film. It is assumed that, when the abundance of cyclic siloxane bonds and chain siloxane bonds is adjusted, silicon and organic chains are regularly arranged, the distribution of the cyclic and chain siloxane bonds is controlled as a surface treatment film, and cyclic siloxane bond portions and chain siloxane bond portions are arranged in a sea-island form, thereby being able to have an extremely excellent performance of such a film.

When, as inhibitor components, at least one metal compound (X) selected from a group consisting of a titanium compound and a zirconium compound, a phosphate compound (Y), and a fluorine compound (Z) are complexed in a base film as such a film forming component, the corrosion resistance is improved. The compounds are present as dense precipitation films in an interface between a base film and a metal to be treated, and the precipitation films exhibit an excellent barrier effect against corrosive factors. Furthermore, a portion of the compounds remain as an eluting inhibitor even in the base film and also has an effect of repairing a film defect portion.

It is particularly preferable in view of corrosion resistance that titanium hydrofluoric acid and/or zirconium hydrofluoric acid corresponding to both of at least one metal compound (X) selected from a group consisting of a titanium compound and a zirconium compound and a fluorine compound (Z) are used as inhibitor components to be added to an aqueous metal surface-treatment agent as in the embodiments of the present invention. The corrosion resistance-exhibiting mechanism is assumed to be as follows. When the surface of a metal material is coated with an aqueous metal surface-treatment agent, the pH is increased very near the surface of the metal material to be treated by etching reaction, a portion of F is dissociated, and a dense metal oxide-based film and/or a metal hydroxide-based film (at least one compound selected from a group consisting of a titanium compound and a zirconium compound) is formed. In addition, the dissociated F forms a composite compound film (F compound) with the organic silicon compound or the metal material to be treated. The film, as described above, exhibits excellent barrier effects against corrosion factors. It is assumed that a composite film of the present invention, which is made based on such a corrosion resistance-exhibiting mechanism, exhibits heat resistance, anti-fingerprint property, electrical conductivity, paintability, black shaving resistance during processing, and excellent corrosion resistance.

### Example

Hereinafter, the present invention will be specifically described with reference to Examples and Comparative Examples. However, the present invention is not limited thereto. The preparation of a test sheet, Examples and Comparative Examples, and a method of coating a surface treatment agent for a metal material will be described below.

Preparation of Test Sheets

(1) Test Materials

The commercially available materials described below were used.

Electrolytic zinc-plated steel sheet (EG): sheet thickness=0.8 mm, amount of plating=20/20 (g/m²)

Hot-dip galvanized steel sheet (GI): sheet thickness=0.8 mm, amount of plating=90/90 (g/m²)

Electrogalvanized-12% nickel plating (ZL): sheet thickness=0.8 mm, amount of plating=20/20 (g/m²)

Hot-dip zinc-11% aluminum-3% magnesium-0.2% silicon plating (SD): sheet thickness=0.8 mm, amount of plating=60/60 (g/m²)

where “amount of plating” indicates a weight (g) per unit area (1 m²).

(2) Degreasing Treatment

A silicate-based alkali degreasing agent “FINECLEANER 4336” (manufactured by Nihon Parkerizing Co., Ltd.) was sprayed on a material for two minutes on condition that a concentration is 20 g/L and a temperature is 60° C., was washed with pure water for 30 seconds and was dried to obtain a test sheet.

Silane coupling agents used in the Examples and Comparative Examples are illustrated in Table 1; synthetic organic silicon compounds (W) are illustrated in Table 2; cobalt compounds (C) are illustrated in Table 3; and blending of the Examples and Comparative Examples used in the tests are illustrated in Tables 4 to 5.

[A Method of Adjusting Organic Silicon Compounds W1 to W13]

Silane coupling agents (A) and silane coupling agents (B) illustrated in Table 1 were sequentially added to ion-exchanged water adjusted to pH 4 and a predetermined temperature, the resultant solution was agitated for a predetermined time while being controlled at a predetermined temperature, and thus, the organic silicon compounds W1 to W13 illustrated in Table 2 were obtained.

[A Method of Adjusting Organic Silicon Compound W14 for Comparison]

The silane coupling agents (A) and the silane coupling agents (B) illustrated in Table 1 were sequentially added to ion-exchanged water adjusted to pH 4, the resultant solution was agitated for a predetermined time without a temperature control (cooling), and thus, an organic silicon compound W14 for the comparison illustrated in Table 2 was obtained.

[Organic Silicon Compounds W15 to W17 for Comparison]

Organic silicon compounds according to Examples 1, 3 and 5 of Japanese Unexamined Patent Application, First Publication No. 2007-51365 were adjusted by use of adjustment methods of the publication to obtain organic silicon compounds W15 to W17 for the comparison.

[Urethane Resin for Comparison]

Polyether polyol (synthetic components: tetramethylene glycol and ethylene glycol, molecular weight 1,500) (150 parts by mass), 6 parts by mass of trimethylolpropane, 24 parts by mass of N-methyl-N,N-diethanolamine, 94 parts by mass of isophorone diisocyanate and 135 parts by mass of methyl ethyl ketone were put into a reaction vessel and subjected to reaction for 1 hour while a temperature was maintained at 70° C. to 75° C. to produce urethane prepolymer. Subsequently, 15 parts by mass of dimethyl sulfate was put into the reaction vessel and subjected to reaction for 30 to 60 minutes at 50° C. to 60° C. to produce cationic urethane prepolymer. Subsequently, 576 parts by mass of water was put into the reaction vessel, the mixture was uniformly emulsified, and methyl ethyl ketone was recovered to obtain water-soluble cationic urethane resin. The mean molecular weight of the obtained urethane resin was measured to be 100,000 by use of a chromatographic method according to TOF-MS.

[Acrylic Resin for Comparison]

Styrene (25 parts by mass), 25 parts by mass of butyl acrylate, 20 parts by mass of acrylonitrile, 15 parts by mass of acrylic acid, 10 parts by mass of hydroxyethyl acrylate and 5 parts by mass of N-methylol acrylamide were copolymerized in an reaction vessel to form acrylic resin. The produced acrylic resin (300 parts by mass), 700 parts by mass of water and 0.5 parts by mass of polyoxyethylene-based emulsifier were mixed and forcibly emulsified by use of an agitator. A mean molecular weight of the obtained acrylic resin was measured to be 50,000 by use of a chromatographic method according to TOF-MS.

[Phenol Resin for Comparison]

Phenol (1 mole) and 0.3 g of p-toluenesulfonic acid as a catalyst were put into a 1,000-ml flask provided with a reflux condenser, the internal temperature was increased to 100° C., 0.85 moles of aqueous formaldehyde solution was added over 1 hour, and the mixture was subjected to reaction under reflux for 2 hours at 100° C. Thereafter, the reaction vessel was cooled in water and turbidity of an aqueous layer to be split into an upper layer disappeared, the aqueous layer was removed by decantation, the mixture was heated and agitated to a temperature of 170 to 175° C. to remove unreacted contents and water. Next, after the temperature was decreased to 100° C. and polycondensate was completely dissolved by adding 234 g of butyl cellosolve, 234 g of pure water was added, 1 mole of diethanolamine was added when the temperature in the system was decreased to 50° C., and 1 mole of aqueous formaldehyde solution was dropped into the system over approximately 1 hour at 50° C. Furthermore, the temperature was increased to 80° C., the mixture continued to be subjected to reaction while being agitated for approximately 3 hours to obtain cationic phenol-based polycondensate. The mean molecular weight of the obtained phenol resin was measured to be 6,000 by use of a chromatographic method according to TOF-MS.

[Epoxy Resin for Comparison]

Bisphenol A polypropylene oxide 2 mole adduct (180 parts by mass) was put into a reaction vessel, heated and agitated. Boron trifluoride diethylether complex (0.9 parts by mass) was added as a catalyst, 27 parts by mass of 2-ethylhexyl monoglycidyl ether (epoxy equivalent 198) was dropped thereto over 1 hour at 60° C. to 70° C., the mixture was aged for 1.5 hours as it was, and additionally subjected to reaction. After disappearance of oxirane rings in the system was confirmed by hydrochloric acid absorption, boron trifluoride ethylether complex was deactivated with 3 parts by mass of 48 mass % sodium hydroxide. While 370 parts by mass of epichlorohydrin and 1.4 parts by mass of tetramethylammonium chloride were added, epichlorohydrin was refluxed under reduced pressure at 50° C. to 60° C., 109 parts by mass of 48 mass % sodium hydroxide was dropped, the produced hydroxyl group was refluxed and dehydrated. After the completion of droppage, the dehydration reaction was progressed while refluxing and dehydration were performed for 3 hours. The produced sodium chloride was removed by filtration. Excessive epichlorohydrin was distilled under reduced pressure. The obtained resin had expoxy equivalent 283, viscosity 1,725 mPa·s (25° C.) and total chlorine content 0.4 mass %. The obtained epoxy resin (300 parts by mass) and 700 parts by mass of water were mixed, 3.0 parts by mass of polyoxyethylene emulsifier was added, and the mixture was forcibly emulsified with an agitator. The mean molecular weight of the obtained epoxy resin was measured to be 12,000 by use of a chromatographic method according to TOF-MS.

TABLE 1

| | Silane Coupling Agent |
|---|---|
| A1 | 3-aminopropyltrimethoxysilane |
| A2 | 3-aminopropyltriethoxysilane |
| B1 | 3-glycidoxypropyltrimethoxysilane |
| B2 | 3-glycidoxypropyltriethoxysilane |

TABLE 2

| | | | | | | | | Temperature During | | |
|---|---|---|---|---|---|---|---|---|---|---|
| | | | | Number Of | | Cyclic Siloxane | | Manufacturing | | |
| | Silane Coupling Agent | | | Functional | Molecular | Existing/ | | Start | Maximum | |
| | A | B | Ratio | Group (A) | Weight | Non-Existing | W1/W2 | Temperature | Temperature | Remarks |
| W-1 | A1 | B1 | 0.7 | 2 | 1500 | existing | 1.3 | 15 | 20 | |
| W-2 | A1 | B1 | 0.7 | 2 | 1000 | existing | 1.2 | 15 | 21 | |
| W-3 | A1 | B1 | 0.7 | 2 | 10000 | existing | 1.4 | 15 | 20 | |
| W-4 | A2 | B1 | 0.7 | 2 | 2000 | existing | 1.5 | 15 | 19 | |
| W-5 | A2 | B1 | 0.7 | 2 | 2000 | existing | 1.8 | 10 | 18 | |
| W-6 | A2 | B1 | 0.7 | 2 | 2000 | existing | 1.2 | 5 | 22 | |
| W-7 | A2 | B1 | 0.7 | 2 | 2000 | existing | 0.5 | 5 | 43 | |
| W-8 | A2 | B1 | 0.7 | 2 | 2000 | existing | 2.3 | 1 | 12 | |
| W-9 | A1 | B2 | 0.5 | 2 | 3000 | existing | 1.9 | 20 | 25 | |
| W-10 | A1 | B2 | 0.6 | 2 | 3000 | existing | 1.3 | 20 | 28 | |
| W-11 | A1 | B2 | 1.0 | 2 | 3000 | existing | 1.8 | 20 | 27 | |
| W-12 | A1 | B2 | 1.5 | 2 | 3000 | existing | 1.7 | 20 | 25 | |
| W-13 | A1 | B2 | 1.7 | 2 | 3000 | existing | 1.7 | 20 | 24 | |
| W-14 | A2 | B1 | 0.7 | 2 | 2000 | non- | 0 | 25 | 65 | Without temperature control |
| | | | | | | existing | | | | (cooling) |
| W-15 | A1 | B2 | 0.5 | 2 | 3000 | non- | 0 | 25 | 46 | Organic silicon compound |
| | | | | | | existing | | | | (W) of Example 1 of Japanese |
| | | | | | | | | | | Unexamined Patent |
| | | | | | | | | | | Application, First Publication |
| | | | | | | | | | | No. 2007-51365 |
| W-16 | A1 | B2 | 1.0 | 2 | 3000 | non- | 0 | 25 | 52 | Organic silicon compound |
| | | | | | | existing | | | | (W) of Example 3 of Japanese |
| | | | | | | | | | | Unexamined Patent |
| | | | | | | | | | | Application, First Publication |
| | | | | | | | | | | No. 2007-51365 |
| W-17 | A1 | B2 | 1.5 | 2 | 3000 | non- | 0 | 25 | 61 | Organic silicon compound |
| | | | | | | existing | | | | (W) of Example 5 of Japanese |
| | | | | | | | | | | Unexamined Patent |
| | | | | | | | | | | Application, First Publication |
| | | | | | | | | | | No. 2007-51365 |

TABLE 3

| | Cobalt compound (C) |
|---|---|
| C1 | Cobalt Nitrate |
| C2 | Cobalt Sulphate |
| C3 | Cobalt Carbonate |

TABLE 4

| | Blending | | | | | | | | | | | | | |
|---|---|---|---|---|---|---|---|---|---|---|---|---|---|---|
| | | | | | Phosphate | | Cobalt | | | | | Conditions | | |
| | Organic | Ti Or Zr Compound (X), | | | Compound | | Compound | | | | | | Amount | |
| | Silicon | Fluorine Compound (Z) | | | (Y) | | (C) | | V | Organic | | | of a | |
| | Compound | | (Xₛ)/ | (Zₛ)/ | | (Yₛ)/ | | (Cₛ)/ | Com- | Resin | | Mate- | Film | PMT |
| | (W) | Type | (Wₛ) | (Wₛ) | Type | (Wₛ) | Type | (Wₛ) | pound | Type | Amount | rial | g/m² | ° C. |
| Ex. 1 | W-1 | H₂TiF₆ | 0.10 | 0.28 | H₃PO₄ | 0.20 | | | | | | EG | 0.4 | 120 |
| Ex. 2 | W-2 | H₂TiF₆ | 0.10 | 0.28 | H₃PO₄ | 0.20 | | | | | | EG | 0.4 | 120 |
| Ex. 3 | W-3 | H₂TiF₆ | 0.10 | 0.28 | H₃PO₄ | 0.20 | | | | | | EG | 0.4 | 120 |
| Ex. 4 | W-4 | H₂TiF₆ | 0.10 | 0.28 | H₃PO₄ | 0.20 | | | | | | EG | 0.4 | 120 |
| Ex. 5 | W-5 | H₂TiF₆ | 0.10 | 0.28 | H₃PO₄ | 0.20 | | | | | | EG | 0.4 | 120 |
| Ex. 6 | W-6 | H₂TiF₆ | 0.10 | 0.28 | H₃PO₄ | 0.20 | | | | | | EG | 0.4 | 120 |
| Ex. 7 | W-7 | H₂TiF₆ | 0.10 | 0.28 | H₃PO₄ | 0.20 | | | | | | EG | 0.4 | 120 |
| Ex. 8 | W-8 | H₂TiF₆ | 0.10 | 0.28 | H₃PO₄ | 0.20 | | | | | | EG | 0.4 | 120 |
| Ex. 9 | W-9 | H₂TiF₆ | 0.10 | 0.28 | H₃PO₄ | 0.20 | | | | | | EG | 0.4 | 120 |
| Ex. 10 | W-10 | H₂TiF₆ | 0.10 | 0.28 | H₃PO₄ | 0.20 | | | | | | EG | 0.4 | 120 |
| Ex. 11 | W-11 | H₂TiF₆ | 0.10 | 0.28 | H₃PO₄ | 0.20 | | | | | | EG | 0.4 | 120 |
| Ex. 12 | W-12 | H₂TiF₆ | 0.10 | 0.28 | H₃PO₄ | 0.20 | | | | | | EG | 0.4 | 120 |
| Ex. 13 | W-13 | H₂TiF₆ | 0.10 | 0.28 | H₃PO₄ | 0.20 | | | | | | EG | 0.4 | 120 |
| Ex. 14 | W-10 | H₂TiF₆ | 0.10 | 0.28 | H₃PO₄ | 0.20 | | | | | | EG | 0.04 | 120 |
| Ex. 15 | W-10 | H₂TiF₆ | 0.10 | 0.28 | H₃PO₄ | 0.20 | | | | | | EG | 0.2 | 120 |
| Ex. 16 | W-10 | H₂TiF₆ | 0.10 | 0.28 | H₃PO₄ | 0.20 | | | | | | EG | 0.6 | 120 |
| Ex. 17 | W-10 | H₂TiF₆ | 0.10 | 0.28 | H₃PO₄ | 0.20 | | | | | | EG | 1.0 | 120 |
| Ex. 18 | W-10 | H₂TiF₆ | 0.10 | 0.28 | H₃PO₄ | 0.20 | | | | | | EG | 2.2 | 120 |
| Ex. 19 | W-10 | H₂TiF₆ | 0.10 | 0.28 | H₃PO₄ | 0.20 | | | | | | EG | 0.4 | 50 |
| Ex. 20 | W-10 | H₂TiF₆ | 0.10 | 0.28 | H₃PO₄ | 0.20 | | | | | | EG | 0.4 | 70 |
| Ex. 21 | W-10 | H₂TiF₆ | 0.10 | 0.28 | H₃PO₄ | 0.20 | | | | | | EG | 0.4 | 100 |
| Ex. 22 | W-10 | H₂TiF₆ | 0.10 | 0.28 | H₃PO₄ | 0.20 | | | | | | EG | 0.4 | 140 |
| Ex. 23 | W-10 | H₂TiF₆ | 0.10 | 0.28 | H₃PO₄ | 0.20 | | | | | | EG | 0.4 | 170 |
| Ex. 24 | W-10 | H₂TiF₆ | 0.10 | 0.28 | H₃PO₄ | 0.20 | | | | | | EG | 0.4 | 250 |
| Ex. 25 | W-4 | H₂TiF₆ | 0.06 | 0.17 | H₃PO₄ | 0.20 | | | | | | EG | 0.4 | 120 |
| Ex. 26 | W-4 | H₂TiF₆ | 0.07 | 0.20 | H₃PO₄ | 0.20 | | | | | | EG | 0.4 | 120 |
| Ex. 27 | W-4 | H₂TiF₆ | 0.08 | 0.22 | H₃PO₄ | 0.20 | | | | | | EG | 0.4 | 120 |
| Ex. 28 | W-4 | H₂TiF₆ | 0.13 | 0.36 | H₃PO₄ | 0.20 | | | | | | EG | 0.4 | 120 |
| Ex. 29 | W-4 | H₂TiF₆ | 0.14 | 0.39 | H₃PO₄ | 0.20 | | | | | | EG | 0.4 | 120 |
| Ex. 30 | W-4 | H₂TiF₆ | 0.16 | 0.45 | H₃PO₄ | 0.20 | | | | | | EG | 0.4 | 120 |
| Ex. 31 | W-10 | H₂TiF₆ | 0.06 | 0.09 | H₃PO₄ | 0.20 | | | | | | EG | 0.4 | 120 |
| Ex. 32 | W-10 | H₂TiF₆ | 0.07 | 0.11 | H₃PO₄ | 0.20 | | | | | | EG | 0.4 | 120 |
| Ex. 33 | W-10 | H₂TiF₆ | 0.08 | 0.12 | H₃PO₄ | 0.20 | | | | | | EG | 0.4 | 120 |
| Ex. 34 | W-10 | H₂TiF₆ | 0.10 | 0.15 | H₃PO₄ | 0.20 | | | | | | EG | 0.4 | 120 |
| Ex. 35 | W-10 | H₂TiF₆ | 0.13 | 0.20 | H₃PO₄ | 0.20 | | | | | | EG | 0.4 | 120 |
| Ex. 36 | W-10 | H₂TiF₆ | 0.14 | 0.21 | H₃PO₄ | 0.20 | | | | | | EG | 0.4 | 120 |
| Ex. 37 | W-10 | Ti(SO₄)₂ + HF | 0.10 | 0.28 | H₃PO₄ | 0.20 | | | | | | EG | 0.4 | 120 |
| Ex. 38 | W-10 | ZrOCl₂ + HF | 0.10 | 0.28 | H₃PO₄ | 0.20 | | | | | | EG | 0.4 | 120 |
| Ex. 39 | W-10 | Ti(SO₄)₂ + H₂TiF₆ | 0.10 | 0.08 | H₃PO₄ | 0.20 | | | | | | EG | 0.4 | 120 |
| Ex. 40 | W-10 | Ti(SO₄)₂ + H₂TiF₆ | 0.10 | 0.10 | H₃PO₄ | 0.20 | | | | | | EG | 0.4 | 120 |
| Ex. 41 | W-10 | Ti(SO₄)₂ + H₂TiF₆ | 0.10 | 0.15 | H₃PO₄ | 0.20 | | | | | | EG | 0.4 | 120 |
| Ex. 42 | W-10 | H₂TiF₆ + HF | 0.10 | 0.40 | H₃PO₄ | 0.20 | | | | | | EG | 0.4 | 120 |
| Ex. 43 | W-10 | H₂TiF₆ + HF | 0.10 | 0.50 | H₃PO₄ | 0.20 | | | | | | EG | 0.4 | 120 |
| Ex. 44 | W-10 | H₂TiF₆ | 0.10 | 0.28 | H₃PO₄ | 0.15 | | | | | | EG | 0.4 | 120 |
| Ex. 45 | W-10 | H₂TiF₆ | 0.10 | 0.28 | H₃PO₄ | 0.16 | | | | | | EG | 0.4 | 120 |
| Ex. 46 | W-10 | H₂TiF₆ | 0.10 | 0.28 | H₃PO₄ | 0.18 | | | | | | EG | 0.4 | 120 |
| Ex. 47 | W-10 | H₂TiF₆ | 0.10 | 0.28 | H₃PO₄ | 0.25 | | | | | | EG | 0.4 | 120 |
| Ex. 48 | W-10 | H₂TiF₆ | 0.10 | 0.28 | H₃PO₄ | 0.28 | | | | | | EG | 0.4 | 120 |
| Ex. 49 | W-10 | H₂TiF₆ | 0.10 | 0.28 | H₃PO₄ | 0.31 | | | | | | EG | 0.4 | 120 |

TABLE 5

| | Blending | | | | | | | | | | | | | |
|---|---|---|---|---|---|---|---|---|---|---|---|---|---|---|
| | | | | | Phosphate | | Cobalt | | | | | Conditions | | |
| | Organic | Ti Or Zr Compound (X), | | | Compound | | Compound | | | | | | Amount | |
| | Silicon | Fluorine Compound (Z) | | | (Y) | | (C) | | V | Organic | | | of a | |
| | Compound | | (Xₛ)/ | (Zₛ)/ | | (Yₛ)/ | | (Cₛ)/ | Com- | Resin | | Mate- | Film | PMT |
| | (W) | Type | (Wₛ) | (Wₛ) | Type | (Wₛ) | Type | (Wₛ) | pound | Type | Amount | rial | g/m² | ° C. |
| Ex. 50 | W-10 | H₂ZrF₆ | 0.10 | 0.15 | H₃PO₄ | 0.20 | C1 | 0.05 | | | | EG | 0.4 | 120 |
| Ex. 51 | W-10 | H₂ZrF₆ | 0.10 | 0.15 | H₃PO₄ | 0.20 | C2 | 0.05 | | | | EG | 0.4 | 120 |
| Ex. 52 | W-10 | H₂ZrF₆ | 0.10 | 0.15 | H₃PO₄ | 0.20 | C3 | 0.05 | | | | EG | 0.4 | 120 |
| Ex. 53 | W-10 | H₂ZrF₆ | 0.10 | 0.15 | H₃PO₄ | 0.20 | C1 | 0.03 | | | | EG | 0.4 | 120 |
| Ex. 54 | W-10 | H₂ZrF₆ | 0.10 | 0.15 | H₃PO₄ | 0.20 | C1 | 0.04 | | | | EG | 0.4 | 120 |
| Ex. 55 | W-10 | H₂ZrF₆ | 0.10 | 0.15 | H₃PO₄ | 0.20 | C1 | 0.06 | | | | EG | 0.4 | 120 |
| Ex. 56 | W-10 | H₂ZrF₆ | 0.10 | 0.15 | H₃PO₄ | 0.20 | C1 | 0.07 | | | | EG | 0.4 | 120 |
| Ex. 57 | W-10 | H₂ZrF₆ | 0.10 | 0.15 | H₃PO₄ | 0.20 | C1 | 0.08 | | | | EG | 0.4 | 120 |
| Ex. 58 | W-10 | H₂TiF₆ | 0.10 | 0.28 | H₃PO₄ | 0.18 | | | VO-AA | | | EG | 0.4 | 120 |
| | | | | | | | | | V/Si = | | | | | |
| | | | | | | | | | 0.12 | | | | | |
| Ex. 59 | W-10 | H₂TiF₆ | 0.10 | 0.28 | H₃PO₄ | 0.18 | | | VO-AA | | | EG | 0.4 | 120 |
| | | | | | | | | | V/Si = | | | | | |
| | | | | | | | | | 0.14 | | | | | |
| Ex. 60 | W-10 | H₂TiF₆ | 0.10 | 0.28 | H₃PO₄ | 0.18 | | | VO-AA | | | EG | 0.4 | 120 |
| | | | | | | | | | V/Si = | | | | | |
| | | | | | | | | | 0.15 | | | | | |
| Ex. 61 | W-10 | H₂TiF₆ | 0.10 | 0.28 | H₃PO₄ | 0.18 | | | VO-AA | | | EG | 0.4 | 120 |
| | | | | | | | | | V/Si = | | | | | |
| | | | | | | | | | 0.20 | | | | | |
| Ex. 62 | W-10 | H₂TiF₆ | 0.10 | 0.28 | H₃PO₄ | 0.18 | | | VO-AA | | | EG | 0.4 | 120 |
| | | | | | | | | | V/Si = | | | | | |
| | | | | | | | | | 0.22 | | | | | |
| Ex. 63 | W-10 | H₂TiF₆ | 0.10 | 0.28 | H₃PO₄ | 0.18 | | | VO-AA | | | EG | 0.4 | 120 |
| | | | | | | | | | V/Si = | | | | | |
| | | | | | | | | | 0.25 | | | | | |
| Ex. 64 | W-6 | H₂ZrF₆ | 0.10 | 0.15 | H₃PO₄ | 0.20 | | | | | | GI | 0.4 | 120 |
| Ex. 65 | W-6 | H₂ZrF₆ | 0.10 | 0.15 | H₃PO₄ | 0.20 | C1 | 0.05 | | | | GI | 0.4 | 120 |
| Ex. 66 | W-6 | H₂ZrF₆ | 0.10 | 0.15 | H₃PO₄ | 0.20 | | | VO-AA | | | GI | 0.4 | 120 |
| | | | | | | | | | V/Si = | | | | | |
| | | | | | | | | | 0.15 | | | | | |
| Ex. 67 | W-8 | H₂TiF₆ | 0.10 | 0.28 | H₃PO₄ | 0.20 | | | | | | ZL | 0.4 | 120 |
| Ex. 68 | W-8 | H₂TiF₆ | 0.10 | 0.28 | H₃PO₄ | 0.20 | C1 | 0.05 | | | | ZL | 0.4 | 120 |
| Ex. 69 | W-8 | H₂TiF₆ | 0.10 | 0.28 | H₃PO₄ | 0.20 | | | VO-AA | | | ZL | 0.4 | 120 |
| | | | | | | | | | V/Si = | | | | | |
| | | | | | | | | | 0.15 | | | | | |
| Ex. 70 | W-7 | H₂ZrF₆ | 0.10 | 0.15 | H₃PO₄ | 0.20 | | | | | | SD | 0.4 | 120 |
| Ex. 71 | W-7 | H₂ZrF₆ | 0.10 | 0.15 | H₃PO₄ | 0.20 | C1 | 0.05 | | | | SD | 0.4 | 120 |
| Ex. 72 | W-7 | H₂ZrF₆ | 0.10 | 0.15 | H₃PO₄ | 0.20 | | | VO-AA | | | SD | 0.4 | 120 |
| | | | | | | | | | V/Si = | | | | | |
| | | | | | | | | | 0.15 | | | | | |
| Comp. | W-14 | H₂TiF₆ | 0.10 | 0.28 | H₃PO₄ | 0.20 | | | | | | EG | 0.4 | 120 |
| Ex. 1 | | | | | | | | | | | | | | |
| Comp. | W-15 | H₂TiF₆ | 0.10 | 0.28 | H₃PO₄ | 0.20 | | | | | | EG | 0.4 | 120 |
| Ex. 2 | | | | | | | | | | | | | | |
| Comp. | W-16 | H₂TiF₆ | 0.10 | 0.28 | H₃PO₄ | 0.20 | | | | | | EG | 0.4 | 120 |
| Ex. 3 | | | | | | | | | | | | | | |
| Comp. | W-17 | H₂TiF₆ | 0.10 | 0.28 | H₃PO₄ | 0.20 | | | | | | EG | 0.4 | 120 |
| Ex. 4 | | | | | | | | | | | | | | |
| Comp. | W-4 | — | — | — | H₃PO₄ | 0.20 | | | | | | EG | 0.4 | 120 |
| Ex. 5 | | | | | | | | | | | | | | |
| Comp. | W-4 | H₂TiF₆ | 0.04 | 0.11 | H₃PO₄ | 0.20 | | | | | | EG | 0.4 | 120 |
| Ex. 6 | | | | | | | | | | | | | | |
| Comp. | W-4 | H₂TiF₆ | 0.20 | 0.56 | H₃PO₄ | 0.20 | | | | | | EG | 0.4 | 120 |
| Ex. 7 | | | | | | | | | | | | | | |
| Comp. | W-10 | Ti(SO₄)₂ + H₂TiF₆ | 0.10 | 0.05 | H₃PO₄ | 0.20 | | | | | | EG | 0.4 | 120 |
| Ex. 8 | | | | | | | | | | | | | | |
| Comp. | W-10 | H₂TiF₆ + HF | 0.10 | 0.60 | H₃PO₄ | 0.20 | | | | | | EG | 0.4 | 120 |
| Ex. 9 | | | | | | | | | | | | | | |
| Comp. | W-10 | H₂TiF₆ | 0.10 | 0.28 | — | — | | | | | | EG | 0.4 | 120 |
| Ex. 10 | | | | | | | | | | | | | | |
| Comp. | W-10 | H₂TiF₆ | 0.10 | 0.28 | H₃PO₄ | 0.10 | | | | | | EG | 0.4 | 120 |
| Ex. 11 | | | | | | | | | | | | | | |
| Comp. | W-10 | H₂TiF₆ | 0.10 | 0.28 | H₃PO₄ | 0.34 | | | | | | EG | 0.4 | 120 |
| Ex. 12 | | | | | | | | | | | | | | |
| Comp. | W-10 | H₂TiF₆ | 0.10 | 0.28 | H₃PO₄ | 0.20 | | | | Ur resin | 10% | EG | 0.4 | 120 |
| Ex. 13 | | | | | | | | | | | | | | |
| Comp. | W-10 | H₂TiF₆ | 0.10 | 0.28 | H₃PO₄ | 0.20 | | | | Ur resin | 20% | EG | 0.4 | 120 |
| Ex. 14 | | | | | | | | | | | | | | |
| Comp. | W-10 | H₂TiF₆ | 0.10 | 0.28 | H₃PO₄ | 0.20 | | | | Ur resin | 10% | EG | 0.05 | 120 |
| Ex. 15 | | | | | | | | | | | | | | |
| Comp. | W-10 | H₂TiF₆ | 0.10 | 0.28 | H₃PO₄ | 0.20 | | | | Ac resin | 10% | EG | 0.4 | 120 |
| Ex. 16 | | | | | | | | | | | | | | |
| Comp. | W-10 | H₂TiF₆ | 0.10 | 0.28 | H₃PO₄ | 0.20 | | | | Ph resin | 10% | EG | 0.4 | 120 |
| Ex. 17 | | | | | | | | | | | | | | |
| Comp. | W-10 | H₂TiF₆ | 0.10 | 0.28 | H₃PO₄ | 0.20 | | | | Ep resin | 10% | EG | 0.4 | 120 |
| Ex. 18 | | | | | | | | | | | | | | |
| Comp. | W-14 | H₂ZrF₆ | 0.10 | 0.15 | H₃PO₄ | 0.20 | | | | | | GI | 0.4 | 120 |
| Ex. 19 | | | | | | | | | | | | | | |
| Comp. | W-6 | H₂ZrF₆ | 0.10 | 0.15 | H₃PO₄ | 0.20 | | | | Ur resin | 20% | GI | 0.4 | 120 |
| Ex. 20 | | | | | | | | | | | | | | |
| Comp. | W-14 | H₂TiF₆ | 0.10 | 0.28 | H₃PO₄ | 0.20 | | | | | | ZL | 0.4 | 120 |
| Ex. 21 | | | | | | | | | | | | | | |
| Comp. | W-8 | H₂TiF₆ | 0.10 | 0.28 | H₃PO₄ | 0.20 | | | | Ur resin | 10% | ZL | 0.4 | 120 |
| Ex. 22 | | | | | | | | | | | | | | |
| Comp. | W-14 | H₂ZrF₆ | 0.10 | 0.15 | H₃PO₄ | 0.20 | | | | | | SD | 0.4 | 120 |
| Ex. 23 | | | | | | | | | | | | | | |
| Comp. | W-7 | H₂ZrF₆ | 0.10 | 0.15 | H₃PO₄ | 0.20 | | | | Ep resin | 10% | SD | 0.4 | 120 |
| Ex. 24 | | | | | | | | | | | | | | |

[Evaluation Test]

1. SST Flat Portion Test

A rectangular test specimen of 70 mm×150 mm (flat sheet) having end surfaces sealed with tapes was subjected to a salt spray test (SST) for 192 hours according to JIS Z 2371, and was observed for the incidence of white rust and black rust.

<Evaluation Criteria>

A=white rust is less than 3% of total area and black rust is not generated

B=the incidences of white rust and black rust are less than 3% of the total area

C=the incidences of white rust and black rust are equal to or more than 3% of the total area and less than 10%

D=the incidences of white rust and black rust are equal to or more than 10% of the total area and less than 30%

E=the incidences of white rust and black rust are equal to or more than 30% of the total area

2. SST Processed Portion Test

After a central portion of a rectangular test specimen of 70 mm×150 mm (flat sheet) having end surfaces sealed with tapes was extruded for Erichsen test (7 mm extrusion), the test specimen was subjected to salt spray test for 72 hours according to JIS Z 2371 and observed for the incidence of rust in extruded portion.

<Evaluation Criteria>

A=the incidence of rust is less than 5% of total area

B=the incidence of rust is equal to or more than 5% and less than 10% of the total area

C=the incidence of rust is equal to or more than 10% and less than 20% of the total area

D=the incidence of rust is equal to or more than 20% and less than 30% of the total area

E=the incidence of rust is equal to or more than 30% of the total area

3. SST Flat Portion Test after Degreasing

A rectangular test specimen of 70 mm×150 mm was subjected to dipping treatment for 2 minutes by use of a caustic soda-based alkali degreasing agent FINECLEANER L4460 (manufactured by Nihon Parkerizing Co., Ltd.) on condition that a concentration is 20 g/L of FINECLEANER L4460A agent and 12 g/L of FINECLEANER L4460B agent, and a temperature is 60° C. The test specimen was washed with pure water for 30 seconds and dried. The test specimen had end surfaces sealed with tape, was subjected to salt spray test for 72 hours according to JIS Z 2371, and was observed for the incidence of rust.

<Evaluation Criteria>

B=the incidence of rust is less than 10% of the total area

C=the incidence of rust is equal to or more than 10% and less than 20% of the total area

D=the incidence of rust is equal to or more than 20% and less than 30% of the total area

E=the incidence of rust is equal to or more than 30% of the total area

4. SST End Surface Test after Punching

A rectangular test specimen of 70 mm×150 mm had 5 holes (each of 10 mm diameter) opened by the punching tool at the center thereof, was subjected to a salt spray test for 72 hours according to JIS Z 2371 and the rust widths of 5 end surfaces were observed.

B=rust width (maximum out of 5 measurement positions) is smaller than 1 mm

C=rust width (maximum out of 5 measurement positions) is equal to or larger than 1 mm and smaller than 2 mm

D=rust width (maximum out of 5 measurement positions) is equal to or larger than 2 mm and smaller than 3 mm

E=rust width (maximum out of 5 measurement positions) is equal to or larger than 3 mm

5. Heat Resistance Test

A rectangular test specimen of 70 mm×150 mm was heated in an oven for 2 hours at 200° C., had end surfaces sealed with tape, was subjected to a salt spray test for 48 hours according to JIS Z 2371 and observed for the incidence of rust.

<Evaluation Criteria>

B=the incidence of rust is less than 3% of the total area

C=the incidences of rust is equal to or more than 3% and less than 10% of the total area

D=the incidences of rust is equal to or more than 10% and less than 30% of the total area

E=the incidences of rust is equal to or more than 30% of the total area

6. Anti-Fingerprint Properties Test

A test specimen was coated with Vaseline, L values (lightness) were measured, before and after Vaseline was coated, by use of a spectrophotometer (SC-T45 manufactured by Suga Test Instruments Co., Ltd.), and variation (ΔL) was calculated.

<Evaluation Criteria>

B=ΔL is less than 0.5

C=ΔL is equal to or more than 0.5 and less than 1.0

D=ΔL is equal to or more than 1.0 and less than 2.0

E=ΔL is equal to or more than 2.0

7. Electrical Conductivity Test

An interlayer resistance coefficient was measured by JIS C2550-4: 2011-A method on condition that a total area of 10 pieces of contact electrodes is 1,000 mm².

<Evaluation Criteria>

B=interlayer resistance is less than 100 Ω·mm²

C=interlayer resistance is equal to or more than 100 Ω·mm² and less than 200 Ω·mm²

D=interlayer resistance is equal to or more than 200 Ω·mm² and less than 300 Ω·mm²

E=interlayer resistance is equal to or more than 300 Ω·mm²

8. Paintability Test

A test specimen was painted with melamine-alkyd based paint (amilac #1000 white manufactured by Kansai Paint Co., Ltd.) by use of a bar coater to have a film thickness of 25 μm after baking and drying are completed, baked for 20 minutes at 120° C., scored in a grid (1 mm×1 mm) pattern, and subjected to a tape peeling test. Adhesion was evaluated based on the ratio of the number of remaining film grids on the test specimen to the total number of film grids (the number of the remaining film grids/the number of the total film grids (100 grids))

<Evaluation Criteria>

B=100%

C=equal to or more than 95%

D=equal to or more than 90% and less than 95%

E=less than 90%

9. Black Shaving Resistance Test

Three-stage cylindrical deep drawing according to the following press conditions was performed on a cylindrical test specimen having a diameter of 70 mm and lubricated with press oil (PG 3080 manufactured by Nihon Kosakuyu Co. Ltd.) to obtain a stamped article. After press oil attached to the stamped article was removed by use of hexane, black shavings attached to the side walls of the stamped article were recovered by pasting cellophane tape to and peeling from the side walls thereof. L value (blank value) of white paper, which had a cellophane tape pasted thereto, was measured by use of a spectrophotometer (SC-T45 manufactured by Suga Test Instruments Co., Ltd.). Black shavings were removed from the side walls of the stamped article by use of a cellophane tape, and L value of white paper was measured which had the cellophane tape pasted thereto by use of a spectrophotometer (SC-T45 manufactured by Suga Test Instruments Co., Ltd.). The difference (ΔL) between these L values (lightness) was calculated.

### [Press Conditions]

Molding speed: 450 mm/s, fold pressure: 9.8 kN

(First stage) punch diameter: 33.4 mm, punch shoulder radius: 5 mm, die diameter: 35.3 mm, die shoulder radius: 5 mm, molding depth: 35 mm

(Second stage) punch diameter: 26.4 mm, punch shoulder radius: 3 mm, die diameter: 28.2 mm, die shoulder radius: 3 mm, molding depth: 42 mm

(Third stage) punch diameter: 26.4 mm, punch shoulder radius: 3 mm, die diameter: 27.7 mm, die shoulder radius: 3 mm, molding depth: 42 mm

<Evaluation Criteria>

B=ΔL is less than 0.5

C=ΔL is equal to or more than 0.5 and less than 1.0

D=ΔL is equal to or more than 1.0 and less than 2.0

E=ΔL is equal to or more than 2.0

10. SST Test after Deep Drawing

After press oil attached to the stamped article obtained at the test 9 was removed by use of hexane, the test specimen was subjected to salt spray test for 72 hours and observed for the incidence of rust on the side surfaces thereof

<Evaluation Criteria>

A=the incidence of rust is less than 5% of the total area

B=the incidence of rust is equal to or more than 5% and less than 10% of the total area

C=the incidence of rust is equal to or more than 10% and less than 20% of the total area

D=the incidence of rust is equal to or more than 20% and less than 30% of the total area

E=the incidence of rust is equal to or more than 30% of the total area

Test results were illustrated in Tables 6 and 7. Accordingly, when Examples 01 to 13 and Comparative Examples 01 to 04 are compared to each other, Examples 01 to 13 use an organic silicon compound (W) according to the present invention and show excellent performance in corrosion resistance in flat portion, corrosion resistance in processed portion after deep drawing, corrosion resistance after degreasing and corrosion resistance of end surfaces after punching, compared to Comparative Example 01 (temperature is not controlled during manufacturing and cyclic siloxane bonds are not contained) and Comparative Examples 02 to 04 (Examples of Patent Literature, Japanese Unexamined Patent Application, First Publication No. 2007-51365). In addition, Examples 01 to 06 have a more preferable amount of cyclic siloxane bonds of an organic silicon compound (W), and partially or entirely show excellent corrosion resistance compared to Examples 07 and 08. In addition, a surface-treated steel sheet of the present invention shows excellent performance regardless of the amount of film and peak metal temperature (PMT) compared to Examples 14 to 24.

According to comparisons between Examples 25 to 30 and Comparative Examples 05 to 07, when a metal compound (X) is a titanium compound or a zirconium compound, and the amount thereof is within a range of the present invention, the corrosion resistance, electrical conductivity and paintability can be compatible with each other. In addition, when a metal compound (X) is within a preferable range, any metal compound (X) show a good performance in Examples 31 to 36. In addition, according to comparisons between Examples 39 to 43 and Comparative Examples 08 and 09, when the amount of a fluorine compound (Z) is within a range of the present invention, the corrosion resistance, electrical conductivity and paintability are compatible with each other. Similarly, according to comparisons between Examples 44 to 49 and Comparative Examples 10 to 12, when the blending quantity of a phosphate compound (Y) is within the range of the present invention, excellent corrosion resistance, heat resistance, anti-fingerprint properties and paintability are compatible with each other. In addition, when a Co compound or a V compound is contained in a composite film of the present invention, it is possible to obtain more excellent corrosion resistance in a flat portion or processed portion without a remarkable deterioration of performance in Examples 50 to 63. On the other hand, according to Comparative Examples 13 to 18 containing an organic resin, when an organic resin is contained in a composite film, electrical conductivity and black shaving resistance, which are the effects of the present invention, are remarkably deteriorated.

In addition, according to comparisons between Examples 64 to 72 and Comparative Examples 19 to 24, when a composite film of the present invention is formed within a range of the present invention, the film is not affected by a material itself, and any material of electrolytic zinc-plated steel sheet (EG), hot-dip galvanized steel sheet (GI), electrogalvanized-12% nickel plating (ZL) and hot-dip zinc-11% aluminum-3% magnesium-0.2% silicon plating (SD) show good performance.

TABLE 6

| | SST | | | | | | | | | |
|---|---|---|---|---|---|---|---|---|---|---|
| | | Processed Portion | | | | | Anti- | | | Black |
| | Flat | | Deep | After | Punching | Heat | Fingerprint | Electrical | | Shaving |
| | Portion | Erichsen | Drawing | Degreasing | End Surface | Resistance | Properties | Conductivity | Paintability | Resistance |
| Ex. 1 | B | B | B | B | B | B | B | B | B | B |
| Ex. 2 | B | B | B | B | B | B | C | B | B | B |
| Ex. 3 | B | B | B | B | B | B | B | B | B | C |
| Ex. 4 | B | B | B | B | B | B | B | B | B | B |
| Ex. 5 | B | B | B | B | B | B | B | B | B | B |
| Ex. 6 | B | B | B | B | B | B | B | B | B | B |
| Ex. 7 | C | B | B | C | C | B | C | B | B | B |
| Ex. 8 | B | C | C | B | C | B | B | B | C | B |
| Ex. 9 | C | C | C | B | C | B | B | B | B | B |
| Ex. 10 | B | B | B | B | B | B | B | B | B | B |
| Ex. 11 | B | B | B | B | B | B | B | B | B | B |
| Ex. 12 | B | B | B | B | B | B | B | B | B | B |
| Ex. 13 | C | C | C | C | B | C | C | B | B | B |
| Ex. 14 | C | C | C | C | C | B | C | B | B | B |
| Ex. 15 | B | B | B | C | C | B | C | B | B | B |
| Ex. 16 | B | B | B | B | B | B | B | B | B | B |
| Ex. 17 | B | B | B | B | B | B | B | C | B | B |
| Ex. 18 | B | B | B | B | B | C | B | C | B | C |
| Ex. 19 | C | C | C | C | C | B | C | C | C | C |
| Ex. 20 | B | B | B | C | C | B | B | B | B | C |
| Ex. 21 | B | B | B | B | B | B | B | B | B | B |
| Ex. 22 | B | B | B | B | B | B | B | B | B | B |
| Ex. 23 | B | B | B | B | B | B | B | B | B | B |
| Ex. 24 | B | B | C | B | C | B | B | B | C | C |
| Ex. 25 | C | C | C | C | C | C | C | B | C | C |
| Ex. 26 | B | B | B | B | B | B | B | B | B | B |
| Ex. 27 | B | B | B | B | B | B | B | B | B | B |
| Ex. 28 | B | B | B | B | B | B | B | B | B | B |
| Ex. 29 | B | B | B | B | B | B | B | C | C | B |
| Ex. 30 | B | B | C | B | B | B | B | C | C | B |
| Ex. 31 | C | C | C | C | C | C | C | B | C | C |
| Ex. 32 | B | B | B | B | B | B | B | B | B | B |
| Ex. 33 | B | B | B | B | B | B | B | B | B | B |
| Ex. 34 | B | B | B | B | B | B | B | B | B | B |
| Ex. 35 | B | B | B | B | B | B | B | B | B | B |
| Ex. 36 | B | B | C | B | B | B | B | C | C | B |
| Ex. 37 | B | C | C | C | B | B | B | B | C | B |
| Ex. 38 | B | C | C | C | B | B | B | B | C | B |
| Ex. 39 | B | C | C | C | C | B | B | B | C | B |
| Ex. 40 | B | B | B | C | B | B | B | B | C | B |
| Ex. 41 | B | B | B | B | B | B | B | B | B | B |
| Ex. 42 | B | C | C | B | B | B | B | C | C | B |
| Ex. 43 | B | C | C | C | C | B | C | C | C | C |
| Ex. 44 | B | C | C | C | C | B | B | B | B | B |
| Ex. 45 | B | B | B | B | B | B | B | B | B | B |
| Ex. 46 | B | B | B | B | B | B | B | B | B | B |
| Ex. 47 | B | B | B | B | B | B | B | B | B | B |
| Ex. 48 | B | B | B | C | B | C | C | B | C | B |
| Ex. 49 | B | B | B | C | C | C | C | C | C | C |

TABLE 7

| | SST | | | | | | | | | |
|---|---|---|---|---|---|---|---|---|---|---|
| | | Processed Portion | | | | | Anti- | | | Black |
| | Flat | | Deep | After | Punching | Heat | Fingerprint | Electrical | | Shaving |
| | Portion | Erichsen | Drawing | Degreasing | End Surface | Resistance | Properties | Conductivity | Paintability | Resistance |
| Ex. 50 | A | B | B | B | B | B | B | B | B | B |
| Ex. 51 | A | B | B | B | B | B | B | B | B | B |
| Ex. 52 | A | B | B | B | B | B | B | B | B | B |
| Ex. 53 | A | B | B | B | B | B | B | B | B | B |
| Ex. 54 | A | B | B | B | B | B | B | B | B | B |
| Ex. 55 | A | B | B | B | B | B | B | B | B | B |
| Ex. 56 | A | B | B | B | B | B | B | B | B | B |
| Ex. 57 | A | B | B | B | B | B | C | B | B | B |
| Ex. 58 | B | A | B | B | B | B | B | B | B | B |
| Ex. 59 | B | A | B | B | B | B | B | B | B | B |
| Ex. 60 | B | A | A | B | B | B | B | B | B | B |
| Ex. 61 | B | A | A | B | B | B | B | B | B | B |
| Ex. 62 | B | A | A | B | B | C | B | B | B | B |
| Ex. 63 | B | A | A | B | B | C | C | B | B | B |
| Ex. 64 | B | B | B | B | B | B | B | B | B | B |
| Ex. 65 | A | B | B | B | B | B | B | B | B | B |
| Ex. 66 | B | A | A | B | B | B | B | B | B | B |
| Ex. 67 | B | B | B | B | B | B | B | B | B | B |
| Ex. 68 | A | B | B | B | B | B | B | B | B | B |
| Ex. 69 | B | A | A | B | B | B | B | B | B | B |
| Ex. 70 | B | B | B | B | B | B | B | B | B | B |
| Ex. 71 | A | B | B | B | B | B | B | B | B | B |
| Ex. 72 | B | A | A | B | B | B | B | B | B | B |
| Comp. Ex. 1 | D | C | D | D | E | B | B | B | B | B |
| Comp. Ex. 2 | D | C | D | E | D | B | B | B | B | B |
| Comp. Ex. 3 | D | D | D | E | D | B | B | B | B | B |
| Comp. Ex. 4 | D | D | D | E | C | B | B | B | B | B |
| Comp. Ex. 5 | E | E | E | E | E | D | D | B | E | D |
| Comp. Ex. 6 | D | E | E | E | E | C | C | B | D | D |
| Comp. Ex. 7 | B | B | E | B | B | B | B | E | E | B |
| Comp. Ex. 8 | C | C | C | D | D | C | B | B | D | C |
| Comp. Ex. 9 | C | D | D | D | D | B | D | E | E | C |
| Comp. Ex. 10 | D | D | E | E | E | B | B | B | B | B |
| Comp. Ex. 11 | C | D | D | D | D | B | B | B | B | B |
| Comp. Ex. 12 | B | B | B | D | D | D | E | D | D | E |
| Comp. Ex. 13 | B | B | B | B | B | B | B | E | B | E |
| Comp. Ex. 14 | B | B | B | B | B | D | B | E | B | E |
| Comp. Ex. 15 | B | B | B | B | B | B | B | E | B | E |
| Comp. Ex. 16 | B | B | B | B | B | B | B | E | B | E |
| Comp. Ex. 17 | B | B | B | B | B | E | B | E | B | E |
| Comp. Ex. 18 | B | B | B | B | B | E | B | E | B | E |
| Comp. Ex. 19 | D | C | D | D | E | B | B | B | B | B |
| Comp. Ex. 20 | B | B | B | B | B | D | B | E | B | E |
| Comp. Ex. 21 | D | C | D | D | E | B | B | B | B | B |
| Comp. Ex. 22 | B | B | B | B | B | B | B | E | B | E |
| Comp. Ex. 23 | D | C | D | D | E | B | B | B | B | B |
| Comp. Ex. 24 | B | B | B | B | B | E | B | E | B | E |

As described above, a metal material subjected to a chromate-free surface treatment which forms a composite film of the present invention can retain corrosion resistance, heat resistance, anti-fingerprint properties, electrical conductivity, paintability and black shaving resistance during processing, and more specifically, can retain excellent corrosion resistance without being affected by the alkaline degreasing, bending and punching that are conducted when the surface-treated metal material is processed into a stamped article.

### INDUSTRIAL APPLICABILITY

A surface-treated metal material and an aqueous metal surface-treatment agent of the present invention can retain an excellent corrosion resistance without being affected by the alkaline degreasing, bending and punching that are conducted when the surface-treated metal material is processed into a stamped article, and in addition, are excellent in terms of heat resistance, anti-fingerprint property, electrical conductivity, paintability and black shaving resistance during processing. Consequently, the present invention can be preferably used as a surface-treated metal material and an aqueous metal surface-treatment agent.

1. A surface-treated metal material comprising:
a composite film on a surface of a metal material, the composite film comprising
as a film forming component, (i) an organic silicon compound (W) having cyclic siloxane bonds in the structure thereof; and
as inhibitor components, (ii) at least one metal compound (X) selected from a group consisting of a titanium compound and a zirconium compound, (iii) a phosphate compound (Y), and (iv) a fluorine compound (Z);
wherein each of the components of the composite film has:
a ratio of X_{S}/W_{S} from 0.06 to 0.16, where W_{S} is a solid mass of Si derived from the organic silicon compound (W) and X_{S} is a solid mass of at least one metal component selected from a group consisting of Ti and Zr included in the metal compound (X);
a ratio of Y_{S}/W_{S} from 0.15 to 0.31, where W_{S} is the solid mass of Si derived from the organic silicon compound (W) and Y_{S} is a solid mass of P derived from the phosphate compound (Y); and
a ratio of Z_{S}/W_{S} from 0.08 to 0.50, where W_{S} is the solid mass of Si derived from the organic silicon compound (W) and Z_{S} is a solid mass of F derived from the fluorine compound (Z); and
wherein, in the composite film, the amount of an organic resin of which a mean molecular weight is equal to or greater than 3,000 is limited to less than 10 mass % of a total weight of the film.

2. The surface-treated metal material according to claim 1,
wherein an abundance of cyclic siloxane bonds and chain siloxane bonds of the organic silicon compound (W) is a ratio of W₁/W₂ ranging from 1.0 to 2.0, where W₁ is an absorbance of from 1,090 to 1,100 cm⁻¹ indicating the cyclic siloxane bond by the FT-IR reflection method and W₂ is an absorbance of from 1,030 to 1,040 cm⁻¹ indicating the chain siloxane bond.

3. The surface-treated metal material according to claim 1 or 2,
wherein the film forming component does not contain an organic resin of which a mean molecular weight is equal to or greater than 3,000.

4. The surface-treated metal material according to claim 1 or 2,
wherein the film forming component is composed of only the organic silicon compound (W).

5. The surface-treated metal material according to claim 1 or 2,
wherein the metal compound (X) and the fluorine compound (Z) are at least one fluoro compound selected from a group consisting of titanium hydrofluoric acid and zirconium hydrofluoric acid.

6. The surface-treated metal material according to claim 1 or 2,
wherein when an interlayer resistance coefficient is measured by a JIS C2550-4: 2011-A method where a total area of 10 pieces of contact electrodes is 1,000 mm², the coefficient is less than 200 Ω·mm².

7. The surface-treated metal material according to claim 1 or 2,
wherein the composite film contains a cobalt compound (C) at a ratio of C_{S}/W_{S} ranging from 0.03 to 0.08, where W_{S} is the solid mass of Si derived from the organic silicon compound (W) and C_{S} is a solid mass of Co derived from the cobalt compound (C).

8. The surface-treated metal material according to claim 1 or 2,
wherein the metal material is a zinc-plated steel sheet.

9. An aqueous metal surface-treatment agent comprising:
(i) an organic silicon compound (W) having cyclic siloxane bonds in the structure thereof;
(ii) at least one metal compound (X) selected from a group consisting of a titanium compound and a zirconium compound;
(iii) a phosphate compound (Y); and
(iv) a fluorine compound (Z),
wherein each of the components of the aqueous metal surface-treatment agent has:
a ratio of X_{S}/W_{S} from 0.06 to 0.16, where W_{S} is a solid mass of Si derived from the organic silicon compound (W) and X_{S} is a solid mass of at least one metal component selected from a group consisting of Ti and Zr included in the metal compound (X);
a ratio of Y_{S}/W_{S} from 0.15 to 0.31, where W_{S} is the solid mass of Si derived from the organic silicon compound (W) and Y_{S} is a solid mass of P derived from the phosphate compound (Y); and
a ratio of Z_{S}/W_{S} from 0.08 to 0.50, where W_{S} is the solid mass of Si derived from the organic silicon compound (W) and Z_{S} is a solid mass of F derived from the fluorine compound (Z); and
wherein the amount of an organic resin of which a mean molecular weight is equal to or greater than 3,000 is limited to less than 10 mass % of a total solid mass.

10. The aqueous metal surface-treatment agent according to claim 9,
wherein the organic silicon compound (W) is obtained by mixing a silane coupling agent A containing at least one amino group per molecule and a silane coupling agent B containing at least one glycidyl group per molecule at a solid mass ratio A/B ranging from 0.5 to 1.7;
wherein the organic silicon compound (W) contains, per molecule, two or more functional groups (a) represented by a general formula —SiR¹R²R³ and one or more hydrophilic functional groups (b) which have at least one selected from a group consisting of a hydroxyl group and an amino group, where the R¹, R² and R³ are an alkoxy group or a hydroxyl group independently on one another and at least one of the R¹, R² and R³ is an alkoxy group; and
wherein a mean molecular weight of the organic silicon compound (W) is from 1,000 to 10,000.

11. The aqueous metal surface-treatment agent according to claim 9 or claim 10,
wherein the metal compound (X) and the fluorine compound (Z) are at least one fluoro compound selected from a group consisting of titanium hydrofluoric acid and zirconium hydrofluoric acid.

12. A surface-treated metal material,
wherein a surface of a metal material is coated with the aqueous metal surface-treatment agent according to claim 8 or 9 and is dried, and a composite film has a weight of from 0.05 to 2.0 g/m² after drying is completed.
